(19) United States
(12) Patent Application Publication
(10) Pub. No.: US 2013/0073399 A1
(43) Pub. Date: Mar. 21, 2013

(54) SIDETABS

(71) Applicant: Ivan Alexander Celener Nijamkin, Ciudad de Buenos Aires (AR)

(72) Inventor: Ivan Alexander Celener Nijamkin, Ciudad de Buenos Aires (AR)

(73) Assignee: ADMOTION SRL, Ciudad de Buenos Aires (AR)

(21) Appl. No.: 13/234,043

(22) Filed: Sep. 15, 2011

(51) Int. Cl. G06Q 30/02

(52) U.S. Cl. 705/14.73; 705/14.4

(57) ABSTRACT

A system for displaying containers designed for viewing advertisements embedded on a website, wherein the containers can display sorted tabs that emulate the tabs of an address book, the system comprising a client connected via a network to a web page on a Publisher server, a Ad Server connected to the network, a Content Manager server connected to the network, the Content Manager server storing the creative assets and properties, the Ad Server tracking the activity reported by a client using a web browser, and the Content Man-ager server further comprising publishing tools that allow a content Publisher to customize a container according to a variety of parameters and store the parameters of the container in a database

### TECHNICAL FIELD

The present invention relates generally to a web-based advertising container. More specifically to a system, method and user-experience to create manage and track an efficient cross-website advertisement inventory.

### BACKGROUND OF THE INVENTION

One of the main tools available today to a Publisher to monetize the digital content of a web page and/or application is an important variety of on-line advertising, such as display advertising, e-mail marketing, contextual advertising, text links, advertorials, etc.

The present invention is mainly focused, but not limited, to the type of advertising known as “rich media”. This is a variation of display advertising that usually includes video, audio and interactive elements. Another difference respect of conventional advertisements is that is not always displayed within an ad placement, it may “float” over the content or push it. This type of advertisement is usually very attractive for advertisers, as its creative possibili-ties and visual impact are significantly greater.

One of the main Publisher's objectives is creating and maintaining a certain audience within a desired target. Attract viewers to its contents can be expensive, and this is why all aspects that will make a viewer return should be taken in care. Providing a good experience for an end-viewer is a determining factor. A good user experience is mainly defined by the access speed to the contents, navigability, a clear design, a surfing uncluttered by unwanted content or elements, etc.

While browsing a web page or application, the end user unloads a variety of files required to create the experience (text, images, code, data, etc.). Providing a good experience for the end user implies keep the byte size of those files as low and optimal as possible to ensure the best access speed. Obviously, this criterion also applies for the advertisement files.

Monetizing the digital content offering an attractive inventory for the advertisements with-out deteriorating the user experience are objectives that are not always easy to conjugate. Every advertiser wishes his advertisements to have high visibility, e.g. that it appears in the front page or access pages, without requiring a scroll of the content and having prominent screen size. These are some of the variables for pricing the publicity positions. These fea-tures that make a certain position more attractive are the ones that if not properly imple-mented may harm the experience for the end user.

The design of a web page or application is conditioned by the need of supporting a great number of devices with web access and a multitude of screen resolutions. The most fre-quent result is the waste of large screen areas usually on the margins of the content.

Any advertisement solution should always contemplate standard criteria that apply to more than one Publisher. The production of advertisements by the advertiser has associated costs, both in money and time. It is therefore more efficient for an Advertiser the production of advertisements that may be used in more than one web page and/or application.

Another factor from the Publisher's point of view is the need to create friendly user inter-faces that are easy to use and quick to learn, and that are adaptable to new input methods such as for example tactile screens.

### SUMMARY OF THE INVENTION

The present invention provides a user interface and a method for displaying containers de-signed for viewing advertisements embedded on a website. The containers can display sorted tabs that emulates the tabs of an address book.

A Content Manager server stores the creative assets and properties and an Ad Server tracks and stores the activity reported by a client using a web browser. The Content Manager server further comprises publishing tools that allow a content Publisher to customize a con-tainer according to a variety of parameters (e.g., auto-expansion time, vertical coordinate, tab separation, etc.) and store the parameters of the container in a database. The container is associated with the Publisher and can be further associated with a sorted list of tabs.

A container can be embedded into a web page, such as a Publisher's web page, using an embed code that contains a container identifier associated with the specific container in the content manager databases. The embed code, when executed, causes the identified con-tainer to be displayed on the web page according to the customized parameters and tabs associated with the container.

The container includes the basic tab shapes and the logic to download and parse the content data, download the creative assets, render and handle the tabs states and report the interac-tive activity.

Because the container information includes a pointer to its content, a Publisher can change the contents of a container without needing to edit or replace the embed code, and since the container includes a pointer to the content rather than the content itself, the updated content will automatically be referenced by the container. In addition, altering the container does not require to generate a new embed code; consequently, any web page that embeds the container will automatically represent the updated version of the container without any fur-ther required coding.

The features and advantages described in this summary and the following detailed descrip-tion are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram of system architecture for providing embedded tab advertise-ments in accordance with an implementation of the present invention.

FIG. 2 is a process flow for using an embedded container in accordance with an imple-mentation of the present invention.

FIG. 3 is an example interface layout for a container displaying three tabs during the idle state (default state).

FIG. 4 is an example interface layout for a container displaying three tabs during the col-lapsed state.

FIG. 5 is an example interface layout for a container displaying three tabs during the ex-panded state.

FIG. 6 is an example interface layout for each panel.

### DETAILED DESCRIPTION

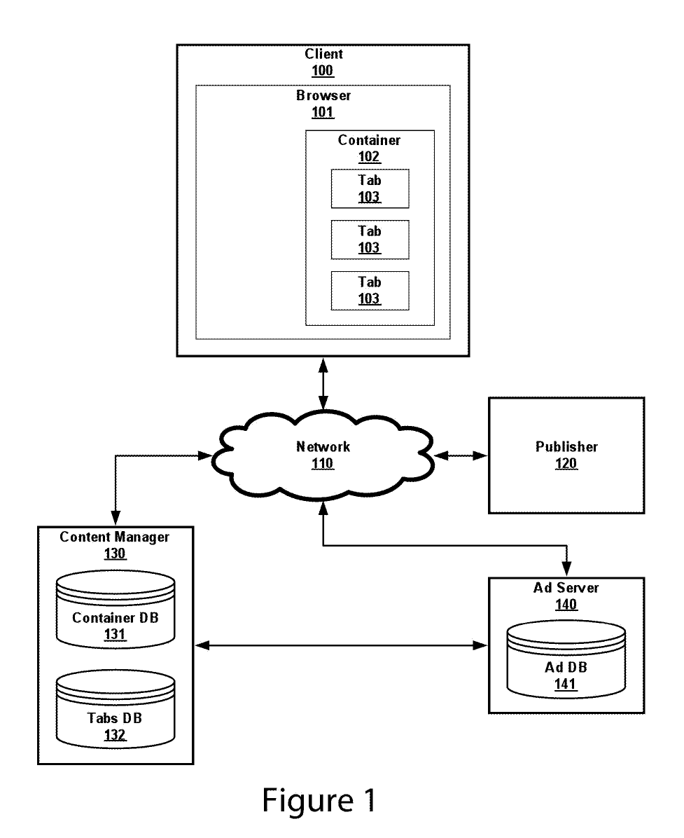

FIG. 1 is a block diagram of a system architecture in accordance with one implementation. Some conventional features, such as firewalls, load balancers, application servers, failover servers, site management tools, and so forth are not shown so as to more clearly illustrate the features of the system. It will be understood that the term “website” represents any method of uploading and downloading content and is not intended to be limited to content uploaded or downloaded via the Internet or the HTTP protocol.

A client 100 accesses a web site using a browser 101, and connects to the Publisher server 120 via a network 110, which is typically the Internet, but may also be any network, including but not limited to a LAN, a MAN, a WAN, a mobile, wired or wireless network, a private network, or a virtual private network. While only a single client 100 and browser 101 are shown, it is understood that very large numbers (e.g., millions) of clients are supported and can be in communication with the website 120 at any time. The container 102, is executed and rendered within the browser 101 and includes multiple tabs 103.

In one implementation, a content Publisher 120 can create and store containers 102 and tabs 103 using a third-party content manager 130 which can be integrated to an Ad Server 140. The integration between the Content Manager 130 and the Ad Server 140 can be made through a variety of technologies, such as REST API, web services, etc.

It's even possible that future Ad Servers 140 may include a Containers Manager feature, leaving aside the need of a Content Manager 130.

In alternative implementations, the Publisher can even skip the use of a Content Manager 130 and store the content data in a static file (e.g., XML, text files, comma separated values, etc.).

The Content Manager 130 allows a Publisher 120 to create a customized embedded container that can be associated with a list of tabs and other container parameters. The tabs created in the Content Manager 130 and stored in the Tabs DB 132 should be associated with an advertisement entity in the Ad DB 141 of the Ad Server 140, to track the metrics related to the tab.

Each tab has its own properties and assets; for example, starting date, color, position, content file, etc. In addition, each tab must have defined the event tracking calls to report the activity metrics to the Ad Server 140. The basic events to track could be impression, tab panel expanded, tab panel collapsed, exposure time, etc.

In one implementation, each container is associated with a unique identification ID that identifies the specific container and its parameters. The container creation module of the Content Manager 130 can furthermore generate and output an embed code that references the created container in the container database 131 by its unique ID.

The embed code is HTML code (or other source code) that can be inserted in the source code of a website. The embed code, when executed by the browser 101, provides a link such as a URL to the container in the container database 131. Thus, when the website is loaded in a browser 101, the browser 101 displays the customized embedded container 102 returned by the content manager website 130. Any display preferences associated with the specific container are also loaded to the embedded container 102.

Finally, the embedded container 102 reads the associated content information provided by the Tabs DB 132, downloads the required assets and renders the tabs 103.

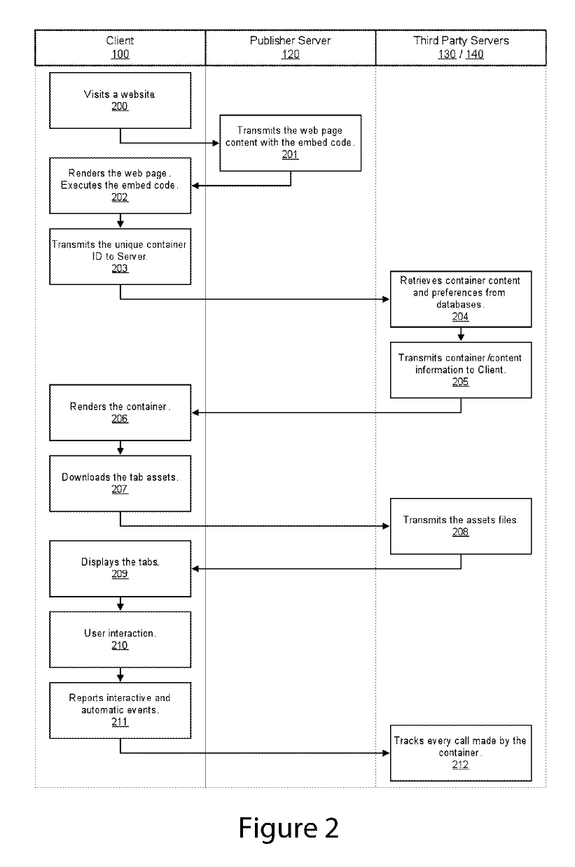

FIG. 2 illustrates a process for providing advertisement content using an embedded container. The process illustrates steps performed by the client 100, the Publisher server 120 and the third-party servers, such as the Content Manager 130 and the Ad server 140. In alternative implementations, different modules or devices may perform the steps. In step 200 the client's browser 101 first loads a website having the embed code associated with a specific container 102 stored in the container database 131. Then in step 203 the browser 101 transmits a container's unique ID to the third-party server 130. In step 204 the server retrieves the container information from the container database 131 and transmits 205 the container and content information to the client 100. The container and content information may include the container implementation code, the container file and the content data. This step can consist of several sub-steps; for example, first a JavaScript code is returned, the browser executes the code and requests the container application file and then the container downloads the content information data. Then in step 206 client's browser 101 renders the container with the appropriate parameters. Once the container has parsed the content information it will start to manage the assets download in step 207. The asset files can be both hosted and delivered through the Content Manager 130 or the Ad Server 140 solution. The assets files will be downloaded 208 only if needed (e.g., a user-interaction requesting content or initial content), so additional asset requests may occur later. It is noted that steps 207 and 208 are optional, and in alternative implementations the container can include all the necessary assets. When all the required assets have been downloaded, the container displays the tabs in step 209. At this step the user can start to interact with the container 210. During the experience the container will report any traceable event in step 211, either user-generated or auto-triggered. The report call 212 is stored in the Ad Server 140 to produce metrics reports.

Using the above described system, the embed code needs only to specify the container ID, and does not need to include the container parameters or content information within the code itself. Thus, a Publisher 120 does not need to re-generate the embed code or re-insert the embed code into the website each time changes are made to the container or content so long as the container ID remains the same. Instead, the Publisher 120 can merely use the publishing tools of the Content Manager 130 to update the content or container preferences associated with the container ID.

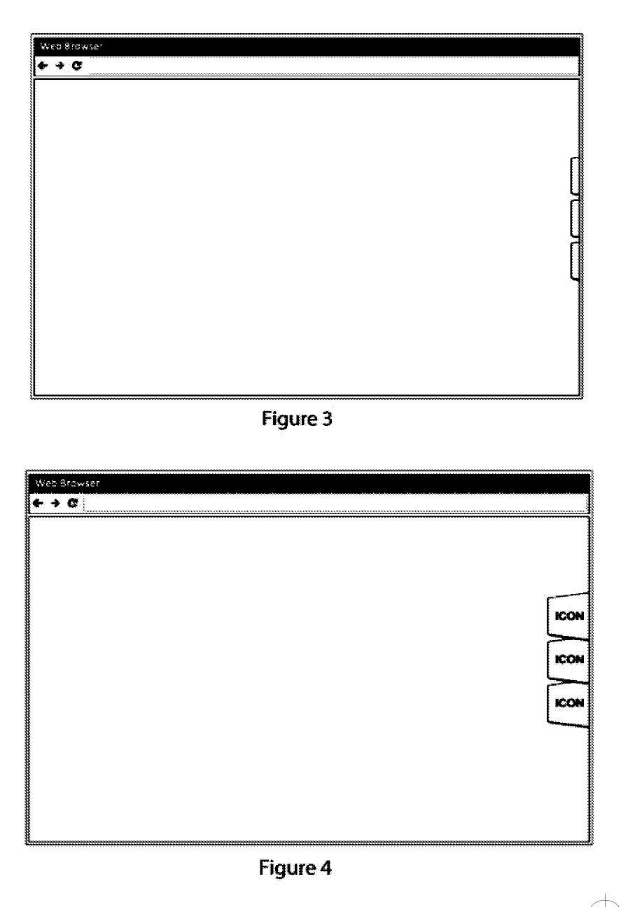

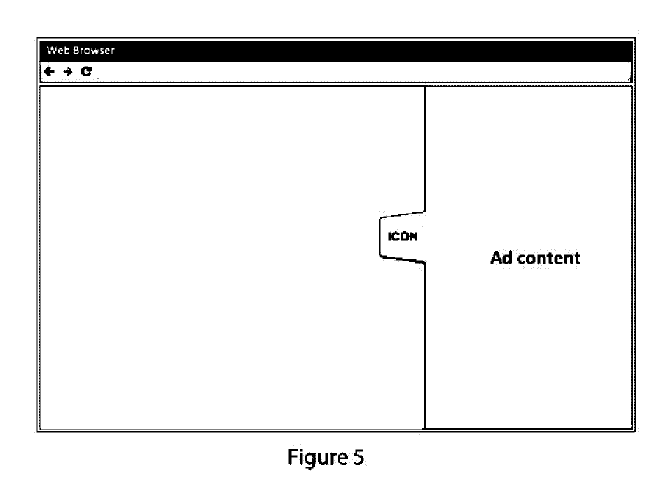

FIG. 3, FIG. 4 and FIG. 5 illustrate the different states of the user experience. It is noted that the tab container can be either left or right aligned. The layout examples show three tabs for illustrative purposes, this number can vary. The browser 101 window representation is used only to frame and clarify the diagrams. The illustrated implementations are included for the sake of example and other variations of container and tabs are possible without departing from the scope of the invention. Furthermore, a Publisher 120 or an advertiser can customize the various aspects of the container and tabs appearance. Each tab represents an ad and the transitions between states can be animated to covey an intuitive usability.

The technology and programming languages used to display the container on the browser 101 may vary according to the client's device, the available tools, Publisher restrictions or any other technical or political reason. It is desirable to support an extensive range of devices and environments, so the use of standards and widely adopted plug-ins or add-ons is expected.

FIG. 3 illustrates the idle state. Only a small portion of the tabs is shown. This is considered the idle state of the container 102; as long as the user doesn't interact with the tabs 103 the container remains in this state. The idle state is intended to produce a non-invasive advertisement experience and to minimize the impact on the web site design, as was described herein. One possible customizable appearance parameter of each tab is its color; which helps to identify and differentiate the tabs 103.

FIG. 4 illustrates the collapsed state. The tabs 103 are completely visible; each one shows a representative icon or image of the ad. The container 102 may switch to this state for two possible reasons: automatic expansion or a user-generated expansion. An automatic expansion is usually used as an eye-catching resource. Optionally, the Publisher 120 can customize behavioral parameters to define when, how many times and for how long the automatic expansion is shown. The user-generated expansion occurs when the user moves the mouse pointer or cursor near or over the idle tabs. This is considered a direct interaction with the container 102. Optionally, a custom message can be displayed when the user rolls over a specific tab 103; which works as a call to action. If the user moves the mouse pointer or cursor away from the tabs 103 the container will return to the idle state.

FIG. 5 illustrates the expanded state. The user has directly interacted with the specific tab (e.g., with a mouse click) and panel 600 is totally opened, fully displaying its tab 103 and content 610. The other tabs are hidden. The panel content assets may download at this moment. Alternatively, a close button is displayed within the panel content 610 to allow the user to close the panel 600 and return to the idle or collapsed state.

The container 102 is rendered above the website content; overlapping every visible object. The container and its content is not affected by the website scroll, it is displayed as a fixed floating element.

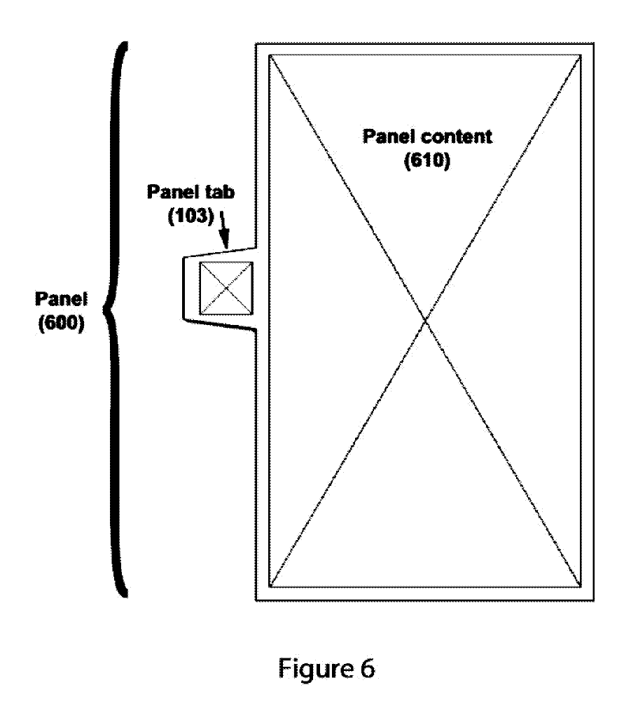

FIG. 6 illustrates a generic panel 600. The shape, proportions and layout may vary. Each panel 600 consists of two main components: the panel tab 103 and the panel content 610. Among the possible customizable appearance aspects of a panel 600 are the color of the panel, the image or icon to display within the panel tab 103, the panel content 610 background image, the panel content assets and the panel content dimensions.

While the tracking of events is optional, it is understood that it is an inherent interest of the advertisement industry. The most common method consists of HTTP requests of the browser 101 to the ad server 140. The requests include unique identifiers to a specific ad and a specific event associated to the ad (e.g., impression event for the ad X or close action event for the ad Y). This method is described only to provide background information; any other method is allowed and do not affect or condition the present invention. Some of the plausible events to track are the following:

a. Collapsed state: the 600 panels are closed, but the tab 103 images are fully visible.

b. Expanded state: the user has opened the panel 600 and the panel content 610 is visible.

c. Close button: the user has closed the panel 600.

d. Tab rollover: the user has moved the mouse pointer or cursor over the tab 103. Optionally, a call to action message was displayed.

e. Click-through: the user has clicked in the panel content 610 and redirected to the advertiser destination site.

f. Exposure time: the time the panel 600 was in the expanded state.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A system for displaying containers designed for viewing advertisements embedded on a website, wherein the containers can display sorted tabs that emulate the tabs of an address book, the system comprising:
an Ad Server connected to the network;
a Content Manager server connected to the network, the Content Manager server storing the creative assets and properties;
the Ad Server configured to track and store activity received from a web browser;
the Content Manager server further comprising publishing tools configured to allow a content Publisher to customize a container according to a plurality of parameters and to store the parameters of the container in a database.

2. The system according to claim 1, wherein the containers are associated with the Publisher and can be further associated with a sorted list of tabs.

3. The system according to claim 2, wherein a container can be embedded into a web page using an embed code that contains a container identifier associated with the specific container in the Content Manager server, the embed code, when executed, causes the identified container to be displayed on the web page according to the customized parameters and tabs associated with the container.

4. The system according to claim 1, wherein container includes the basic tab shapes and the logic to download and parse the content data, download the creative assets, render and handle the tabs states and report the interactive activity.

5. A process for providing electronic advertisement content using an embedded container comprising the steps of:
a) receiving, using a server, an embed code corresponding to a specific container;
b) transmitting, using a server, the container and content information to a client's browser so as to permit the client's browser to render the container with appropriate parameters, and to have the container parse the content information and download assets files so as to have the container display the tabs, the container configured to report any traceable event, either user-generated or auto-triggered using a report call; and
c) producing, using a server, metrics reports based on the report call.

6. The process of claim 5 wherein each time changes are made to the container or content, the embed code only requires to quote the container ID.

7. The process of claim 5 wherein each tab displayed in step g) represents an ad and the transitions between states can be animated to covey an intuitive usability.

8. The process of claim 5 wherein the various aspects of the container and tabs appearance can be customized by a Publisher or an advertiser.
